(19) United States
(12) Patent Application Publication
(10) Pub. No.: US 2026/0240164 A1
(43) Pub. Date: Aug. 20, 2026

(54) DECONTAMINANT COMPOSITION AND USES THEREOF

(71) Applicant: Medivators Inc., Minneapolis, MN (US)

(72) Inventors: Nam Bui, Brooklyn Park, MN (US); Kristopher Murphy, New Brighton, MN (US); Huyen Bui, Brooklyn Park, MN (US); Tuan Nguyen, Chaska, MN (US); Laura Morici, Genzano di Roma (IT); Alessio Immesi, Latina (IT); Andrea Sortino, Rome (IT)

(21) Appl. No.: 19/471,860

(22) PCT Filed: Mar. 29, 2024
(86) PCT No.: PCT/US2024/022288

§ 371 Date: Oct. 2, 2025

Related U.S. Application Data
(60) Provisional application No. 63/493,915, filed on Apr. 3, 2023.

(51) Int. Cl. A01N 59/00; A01N 25/02; A01N 25/30; A01N 37/02; A01N 37/16; A01P 1/00

(52) U.S. Cl. CPC A01N 59/00; A01N 25/02; A01N 25/30; A01N 37/02; A01N 37/16; A01P 1/00

(57) ABSTRACT

Various embodiments disclosed relate to a sterilant composition. The composition includes a first part and a second part. The first part includes a hydrogen peroxide component, an acetic acid component, and a peracetic acid component. The second part includes a buffer component that is substantially free of a borate.

### CLAIM OF PRIORITY AND CROSS-REFERENCE TO RELATED APPLICATION

This application claims the benefit of priority to U.S. Provisional Patent Application Ser. No. 63/493,915 entitled “DECONTAMINANT COMPOSITION AND USES THEREOF,” filed Apr. 3 2023, the disclosure of which is incorporated herein in its entirety by reference.

### BACKGROUND

Various compositions can be used to disinfect a surface. However, despite a composition's ability to effectively disinfect, there can be drawbacks associated with the formulas including a composition's corrosive properties and propensity to leave a residue on the surface. It is desirable to develop disinfecting compositions that are able to disinfect a surface while minimizing undesirable characteristics.

### SUMMARY OF THE INVENTION

Various embodiments disclosed relate to a sterilant composition. The composition includes a first part and a second part. The first part includes a hydrogen peroxide component, an acetic acid component, and a peracetic acid component. The second part includes a buffer component that is substantially free of a borate.

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

According to various aspects of the present disclosure, a sterilant composition is described. The sterilant composition can be applied to various types of surfaces. For example, the surface can be at least a portion of a medical device, at least a portion of an industrial surface, at least a portion of a residential surface, or a combination thereof. An industrial surface can include a floor, wall, countertop, or the like of a disinfect room, hospital, clinic, factory, food-processing plant, or the like. A residential surface can include a floor, wall, countertop, or the like. A particular benefit of the composition is that it is largely anti-corrosive. The anti-corrosive properties of the composition are particularly beneficial when being used to disinfect a medical device such as an endoscope.

The function and benefits of the sterilant composition are a function of the composition's ingredients. Those ingredients are distributed about a respective first and second part of the composition. The first part of the composition can include a hydrogen peroxide component. In the first part the hydrogen peroxide is in a range of from about 100,000 ppm to about 300,000 ppm, about 150,000 ppm to about 250,000 ppm, less than equal to, or greater than about 100,000 ppm, 110,000, 120,000, 130,000, 140,000, 150,000, 160,000, 170,000, 180,000, 190,000, 200,000, 210,000, 220,000, 230,000, 240,000, 250,000, 260,000, 270,000, 280,000, 290,000, or about 300,000 ppm. The hydrogen peroxide component can be in a range of from about 4000 ppm to about 9600 ppm of the sterilant composition when the parts are mixed, about 6000 ppm to about 8000 ppm, less than, equal to, or greater than about 4000 ppm, 4100, 4200, 4300, 4400, 45000, 4600, 4700, 4800, 4900, 5000, 5100, 5200, 5300, 5400, 5500, 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, 7900, or about 8000 ppm.

The first part can further include an acetic acid component. The acetic acid can be in a range of from about 70,000 ppm to about 120,000 ppm in the first part, about 80,000 ppm to about 100,000 ppm, less than, equal to, or greater than about 70,000 ppm, 75,000, 80,000, 85,000, 90,000, 95,000, 100,000, 105,000, 110,000, 115,000, or about 120,000 ppm. When the parts are mixed, the acetic acid component can be in a range of from about 1600 ppm to about 4000 ppm of the sterilant composition, about 2000 ppm to about 3000 ppm, less than, equal to, or greater than about 1600 ppm, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, or about 4000 ppm.

The first part can further include a peracetic acid component. In the first part, the peracetic acid component can be in a range of from about 30,000 ppm to about 70,000 ppm, about 40,000 ppm to about 60,000 ppm, less than, equal to, or greater than about 30,000 ppm, 35,000, 40,000, 45,000, 50,000, 55,000, 60,000, 65,000, or about 70,000 ppm. Once the parts are mixed, the peracetic acid component can be in a range of from about 800 ppm to about 2400 ppm of the sterilant composition, about 1000 ppm to about 2000 ppm, less than, equal to, or greater than about 800 ppm, 900, 1000, 1100, 1200, 1300, 1400, 1500, 1600, 1700, 1800, 1900, 2000, 2100, 2200, 2300, or about 2400.

The first part can further include a stabilizer component. In the first part, the stabilizer component can be in a range of from about 500 ppm to about 25,000 ppm, about 1,000 ppm to about 20,000 ppm, less than, equal to, or greater than about 500 ppm, 1,000, 2,000, 3,000, 4,000, 5,000, 6,000, 7,000, 8,000, 9,000, 10,000, 11,000, 12,000, 13,000, 14,000, 15,000, 16,000, 17,000, 18,000, 19,000, 20,000, 21,000, 22,000, 23,000, 24,000, or about 25,000 ppm. Once the parts are mixed, the stabilizer component can be in a range of from about 20 ppm to about 800 ppm of the sterilant composition, about 50 ppm to about 600 ppm, less than, equal to, or greater than about 20 ppm, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, or about 800 ppm. In some examples, the stabilizer can be 1-hydroxyethylidene-1,1,-diphosphonic acid. In further examples, the stabilizer can be a polymeric stabilizer that is selected from a phosphino polycarboxylic acid, or salt thereof. In some examples, the phosphino polycarboxylic acid has formula (I)

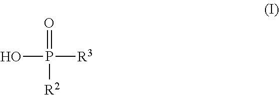

wherein R² is

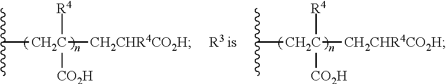

R⁴, at each occurrence, is independently hydrogen or C₁₋₄alkyl; and m and n are each independently an integer, where m+n is an integer from 30 to 60. In some examples, R⁴ is hydrogen. In some examples, the phosphino polycarboxylic acid has a molecular weight of 3300-3900 g/mol.

In some examples, the one or more polymeric stabilizers is selected from a polymer, or salt thereof, with molecular weight of 3000 to 15,000 g/mol, the polymer being derived from a plurality of monomer units of each of

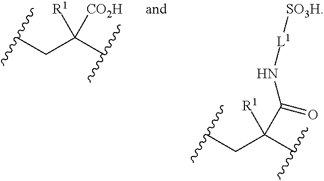

In some examples, the polymer is derived from a plurality of monomer units of each of

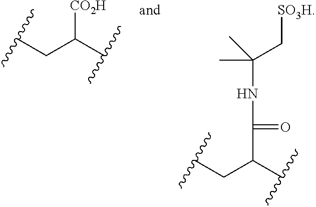

The polymeric stabilizers can include the specified monomer units.

In some examples, the one or more polymeric stabilizers is selected from a polymer, or salt thereof, with molecular weight of 3000 to 15,000 g/mol, the polymer being derived from a plurality of monomer units of each of

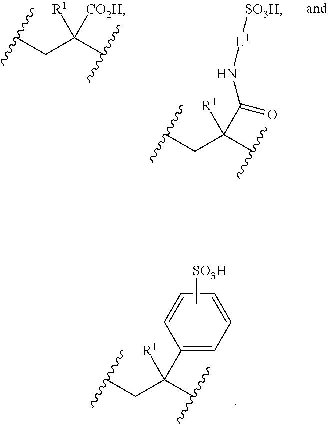

In some examples, the polymer is derived from a plurality of monomer units of each of

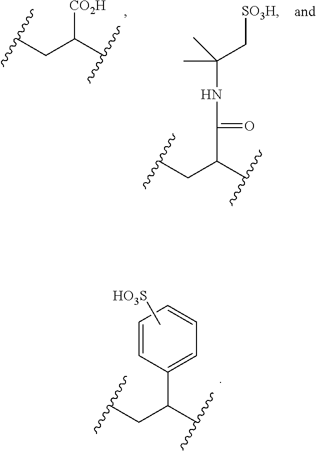

The polymeric stabilizers can include the specified monomer units.

In some examples, the peroxide composition is stabilized with 0.1-1500 ppm of the one or more polymeric stabilizers. The use of the polymeric stabilizer system herein does not preclude or restrict the presence of other known stabilizers for peroxygens. Stabilized peroxyacid compositions of the invention may include additional stabilizers or additives, such as a phosphate, a stannate, or a chelant. Compounds such as polycarboxylic acids, including for example dipicolinic acid, ethylenediaminetetraacetic acid or citric acid, soluble salts of phosphates which may take the form of simple monomeric species, or of condensed linear polyphosphates or cyclic metaphosphates. Further known stabilizers which may be included are organophosphonates, which molecules may additionally contain other functional groups such as hydroxy or amino. These are exemplified in compounds such as 1-hydroxyethylidene-1,1-diphosphonic acid and poly(methyleneamino)-phosphonic acids such as aminotri(methylenephosphonic acid), and diethylenetriaminepenta(methylenephosphonic acid).

Useful stannates include an alkali metal stannate, particularly sodium stannate (Na₂(Sn(OH)₆). Stannates further include stannic chloride, stannic oxide, stannic bromide, stannic chromate, stannic iodide, stannic sulfide, tin dichloride bis(2,4-pentanedionate), tin phthalocyanine dichloride, tin acetate, tin t-butoxide, di-n-butyl tin(IV) dichloride, tin methacrylate, tin fluoride, tin bromide, stannic phosphide, stannous chloride, stannous fluoride, stannous pyrophosphate, sodium stannate, stannous 2-ethylhexoate, stannous bromide, stannous chromate, stannous fluoride, stannous methanesulfonate, stannous oxalate, stannous oxide, stannous sulfate, stannous sulfide, barium stannate, calcium stannate, copper (II) stannate, lead stannate dihydrate, zinc stannate, sodium stannate, potassium stannate trihydrate, strontium stannate, cobalt (II) stannate dihydrate, sodium trifluorostannate, ammonium hexachlorostannate, and lithium hexafluorostannate.

Another optional component of the stabilized peroxy acid compositions is the soluble salt of a phosphate. The phosphate salt can take the form of the simple monomeric species, or of the condensed linear polyphosphate, or cyclic polyphosphate (metaphosphate). The monomeric phosphate salts are of the general formula, MₙH_{q}PO₄, (in which q=0, 1, or 2; n=1, 2, or 3; n+q=3). Here M can be one or more monovalent cations selected from the following: Li, Na, K, NH₄, NR₄ (where R represents an alkyl chain containing 1 to 5 C atoms). The polyphosphates have the general formula, Mₙ₊₂PₙO₃ₙ₊₁ where n=2 to 8, and M can be chosen from Li, Na, K, NH₄, NR₄ where R represents an alkyl chain containing 1 to 5 C atoms). The cyclic polyphosphates have the general formula MₙPₙO₃ₙ where n=3 to 8 and M can be chosen from Li, Na, K, NH₄, NR₄ where R represents a linear or branched alkyl group containing 1 to 5 C atoms).

The above may be optionally introduced into the stabilizer system in their acid form. Exemplary phosphates include pyrophosphoric acid and metaphorphoric acid and their salts, e.g., sodium salts

Any phosphonic acid based chelant can optionally be used, such as amino trimethylene phosphonic acid (ATMP), 2-phosphonobutane-1,2,4-tricarboxylic acid (PBTCA), N-sulfonic amino dimethylene phosphonic acid (SADP), methylamine dimethylene phosphonic acid (MADMP), glycine dimethyl phosphonic acid (GDMP), 2-hydroxyphosphonocarboxylic acid (HPAA), polyhydric alcohol phosphate ester (PAPE), 1-hydroxyethylidene-1,1-diphosphonic acid (HEDP), 1-aminoethane-1,1-diphosphonic acid, amino tri(methylenephosphonic acid) (ATMP), ethylene diamine tetra(methylenephosphonic acid), hexamethylene diamine tetra(methylenephosphonic acid), diethylenetriamine penta(methylenephosphonic acid) (DTPMP), diethylenetriamine hexa(methylenephosphonic acid), and 1-aminoalkane-1,1-diphosphonic acids such as morpholinomethane diphosphonic acid, N,N-dimethyl aminodimethyl diphosphonic acid, aminomethyl diphosphonic acid, or salts thereof, for example sodium salts.

Yet further stabilizers to be contemplated are free radical scavengers. Useful radical scavengers include pyridine carboxylic acids, such as 2,6-pyridine dicarboxylic acid and picolinic acid. Scavengers may be selected from amongst phenols, polyols, or thiols. Suitable scavengers are those selected from phenols which satisfy the general formula (II)

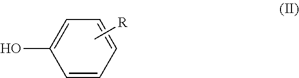

in which R represents at least one substituent selected from alkyl, ether, hydroxyl, carboxylic acid, and aliphatic carboxylic acid ester groups. Normally R in (II), represents from 1 to 4 substituents. One suitable sub-class of phenolic scavengers polyhydroxybenzoic acid or alkyl ester derivatives thereof, the benzene nucleus optionally being further substituted by one or more alkyl substituents. Normally not more than a single carboxylic acid/ester substituent is present. Included within that sub-class are the dihydroxybenzoic acids, gallic acid, pyrogallic acid and ester derivatives thereof. Other suitable sub-classes comprise polyhydroxy alkylbenzenes or ether derivatives thereof. Representatives of that subgroup include alkylresorcinols and alkylhydroquinones. Further suitable radical scavengers are substituted polyaryl compounds including those where one or more of the aryl rings is substituted with a heteroatom. A suitable example from this group is 8-hydroxyquinoline.

Also to be contemplated as phosphorus containing salts are organophosphonates which may be introduced as a soluble salt or as the parent acid. Compounds which may be contemplated include, ethylphosphonic acid, propylphosphonic acid, butylphosphonic acid, t-butylphosphonic acid, or phenylphosphonic acid. Additionally the phosphonic acid molecules can contain other functional groups such as hydroxy or amino. These are exemplified in compounds such; as 1-hydroxyethylidene-1,1-diphosphonic acid, and poly(methyleneamino)phosphonic acids such as aminotri(methylene phosphonic acid), and diethylenetriaminepenta(methylenephosphonic acid).

Further additives which may be contemplated are sulphuric acid, or soluble salts thereof. Organosulphonic acids such as decylsulphonic acid, dodecylsulphonic acid, toluenesulphonic acid and methylsulphonic acid, as well as their salts, may also be introduced. Stannate may be employed at a concentration of up to 15% of the total stabilizer composition, or at a concentration of between 8 to 12%

It is to be understood that the composition of the disclosure can include mixtures of one or more polymeric stabilizers, two or more of at least one protective colloid at least one radical scavenger and at least one phosphonic acid based chelant.

The first part of the composition is kept separated from the second part of the composition until use. When the composition is used the first and second parts are combined. The second part of the composition can include a buffer component. In the second part, the buffer component can be in a range of from about 2300 ppm to about 130,000 ppm, about 2300 ppm to about 120,000 ppm, less than, equal to, or greater than about 40,000, 50,000, 60,000, 70,000, 80,000, 90,000, 100,000, 110,000, 120,000, or about 130,000 ppm. Once the parts are mixed, the buffer component is in a range of from about 800 ppm to about 4800 ppm of the sterilant composition, about 2000 ppm to about 4000 ppm, less than, equal to, or greater than about 800 ppm, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, or about 4000 ppm. The buffer component is substantially free of borate. This can help to reduce the corrosive nature of the composition to a surface it is applied to. For example, the buffer can include less than 2 wt % borate, less than 1 wt % borate, less than 0.5 wt % borate, or even 0 wt % borate. An example of a suitable buffer component is an ammonium acetate buffer. The buffer can help to maintain a pH in the composition in a range of from about 3 to about 7, about 4 to about 6, less than, equal to, or greater than about 3, 3.5, 4, 4.5, 5, 5.5, 6, 6.5, or about 7.

The second part can further include an anti-corrosive component. The anti-corrosive component helps to reduce corrosion caused by the composition on the surface to which it is applied. The anti-corrosive component can be in a range of from about 100 ppm to about 600 ppm of the sterilant composition, 200 ppm to about 400 ppm, less than, equal to, or greater than about 100 ppm, 150, 200, 250, 300, 350, 400, 450, 500, 550, or about 600 ppm. The anti-corrosive component can be a triazole (a heterocyclic compound featuring a five-membered ring of two carbon atoms and three nitrogen atoms with molecular formula C₂H₃N₃. such as benzotriazole).

The second part can further include a solubilizer component. In the second part, the solubilizer component can be in a range of from about 30,000 ppm to about 70,000 ppm, about 40,000 ppm to about 60,000 ppm, less than, equal to, or greater than about 30,000 ppm, 35,000, 40,000, 45,000, 50,000, 55,000, 60,000, 65,000 or about 70,000 ppm. Once the parts are mixed, the solubilizer component can be in a range of from about 800 ppm to about 2400 ppm of the sterilant composition, about 1000 ppm to about 2000 ppm, less than, equal to, or greater than about 800 ppm, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000, 2050, 2100, 2150, 2200, 2250, 2300, 2350, or about 2400 ppm. The solubilizer component can include a glycol. An example of a suitable glycol is propylene glycol.

The second part can include a disinfecter component. In the second part, the disinfector component can be in a range of that can range from about 400 ppm to about 5000 ppm, about 500 ppm to about 3,000 ppm, less than equal to, or greater than about 400 ppm, 500, 600, 700, 800, 900, 1,000, 2,000, 3,000, 4,000, or about 5,000 ppm. Once the parts are mixed the disinfector component can range from about 800 ppm to about 2400 ppm of the sterilant composition, about 1000 ppm to about 2000 ppm, less than, equal to, or greater than about 800 ppm, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000, 2050, 2100, 2150, 2200, 2250, 2300, 2350, or about 2400 ppm. The disinfecter component can include a glycol. An example of a suitable disinfecter includes a diethylene glycol monoethyl ether.

The second part can further include a surfactant component or a stabilizer. The surfactant or stabilizer component can be in a range of from about 104 ppm to about 2140 ppm of the sterilant composition, about 500 ppm to about 1000 ppm, less than, equal to, or greater than about 100 ppm, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000 or about 2140 ppm. The surfactant can include caprylamidopropyl hydroxypropyl sultaine, a diethylene glycol monoethyl ether, or a mixture thereof while the stabilizer can include 2,6-diphenyl-4,8 diazoadamantan-1-one or derivative thereof. Details of this stabilizer can be found in published PCT patent application no. WO 2008/078208, the contents of which are hereby incorporated by reference. The stabilizer can be present in a range of from about 0.0104 wt % to about 0.2140 wt % of the biocidal composition, about 0.02 wt % to about 0.3 wt %, less than, equal to, or greater than about 0.04 wt %, 0.08, 0.09, 0.10, 0.11, 0.12, 0.13, 0.14, 0.15, 0.16, 0.17, 0.18, 0.19, 0.20 or about 0.21 wt %

When the first part and the second part are combined, along with water, they form a dispersible sterilant composition. A dilution ratio of the first part to the second part to the water is about 0.9-1.1:0.9-1.1:47.8-48.2, about 0.9:0.9:48.2 to 1.1:1.1:47.8, or about 1:1:48. A dilution ratio of the first part to the second part is about 1.8-2.2:47.8-48.2, about 1.8:48.2, 1.9:48.1, 2:48, 2.1:47.9, or about 2.2:47.8. A dilution ratio of the first part to the second part to the water is about 1.6-2:8-8.4:39.6-40.4, about 1.6:8:40.4, 1.7:8.1:40.2, 1.8:8.2:40, 1.9:8.3:39.8, or about 2:8.4:39.6. A dilution ratio of the first part to the second part to the water is about 1.8-2.2:2.6-3:44.8-45.6, about 1.8:2.6:45.6, 1.9:2.7:45.4, 2:2.8:45.2, 2.1:2.9:45, or about 2.2:3:44.8.

At the time of application, the first part and second part can be combined with a common source of water and together applied to the surface to be disinfected. The composition can be at a temperature in a range of from about 20° C. to about 50° C., about 30° C. to about 40° C., less than, equal to, or greater than about 20° C., 21, 22, 23, 24, 25, 26, 27, 28, 29, 30, 31, 32, 33, 34, 35, 36, 37, 38, 39, 40, 41, 42, 43, 44, 45, 46, 47, 48, 49, or about 50° C.

The composition of the present invention can be formulated for application, depending upon the user's preference as well as the ultimate application of the composition. For example, the composition can be formulated for use in a sprayable composition, atomized liquid sprayer, or liquid applicator. Such formulations can include at least one of a spray bottle, motorized sprayer, wipe, cloth, sponge, non-woven fabric, and woven fabric. Such formulations may be particularly suitable for applying the composition to a surface of a hospital, physician's office, medical clinic, medical facility, dental office, dental facility, airport, school, pet store, zoo, children's day care, elderly nursing home, museum, movie theatre, athletic facility, sporting arena, gymnasium, rest room, bathroom, shopping center, amusement park, church, synagogue, mosque, temple, restaurant, food processing facility, food manufacturing facility, pharmaceutical company, hot-tub, sauna, and/or disinfect room. Such liquid formulations may be particularly suitable for applying the composition to metal, plastic, natural rubber, synthetic rubber, glass, stone, grout, fiberglass, wood, concrete, construction products, and/or building products.

Packaging materials (e.g., for food) may be disinfected with the stabilized peroxyacid compositions described herein. In some examples, the packaging material is made of PET. In some examples, the packaging material is contacted with the stabilized peroxyacid composition for sufficient time to disinfect the packaging material. In some examples, the process is a rinser cold disinfection, which rinses bottles (upside down) with an aqueous disinfectant composition, mostly based on a peroxy acid (e.g., peracetic acid) as active chemical. A second washing step with clear water must follow to remove remaining disinfectant. The rinser approach does not need high temperatures and is also named cold aseptic. Average consumption of peracetic acid is about 0.2-0.5 ml per unit.

The composition of the present disclosure can be used to effectively reduce the number of microbes located upon a substrate. In specific examples, the composition can effectively kill and/or inhibit a microorganism (e.g., virus, fungus, mold, slime mold, algae, yeast, mushroom and/or bacterium), thereby disinfecting the substrate. While not so limited examples of microbes the composition can effectively kill (e.g., >4 log or >6 log reduction) include S. aureas, P. Aeruginosa, T. interdigitale, B. subtilis, poliovirus, and minute virous of mouse.

In additional specific examples, the composition can effectively sanitize a substrate, thereby simultaneously disinfecting and disinfecting the substrate. In additional specific examples, the composition can effectively kill or inhibit all forms of life, not just microorganisms, thereby acting as a biocide. The contact time needed to effectively kill and/or inhibit a microorganism can range from about 2 minutes to about 60 minutes, about 5 minutes to about 10 minutes, less than equal to, or greater than about 2 minutes, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or about 60 minutes.

In specific examples, the composition of the present invention can be non-toxic. The term “non-toxic” refers to a substance that has a relatively low degree to which it can damage a living or non-living organism. Toxicity can refer to the effect on a whole organism, such as an animal, bacterium, or plant, as well as the effect on a substructure of the organism, such as a cell (cytotoxicity) or an organ (organotoxicity), such as the liver (hepatotoxicity). A central concept of toxicology is that effects are dose-dependent; even water can lead to water intoxication when taken in large enough doses, whereas for even a very toxic substance such as snake venom there is a dose below which there is no detectable toxic effect. Having the composition be relatively non-toxic will allow a wider range of users be able to safely handle the composition, without serious safety concerns or risks

The present invention also provides for a kit that includes: (a) an enclosed container that includes a removable closure; (b) the composition of the present invention as described herein, which is located inside the enclosed container; and (c) printed indicia located on the enclosed container

In specific examples, the enclosed container can be opaque. In additional specific examples, the enclosed container can be manufactured from high density polyethylene (HDPE), thereby providing the requisite opacity. Having the enclosed container be manufactured from high density polyethylene (HDPE) will decrease the likelihood that the composition will degrade and/or decompose over extended periods of time, due to excessive exposure to direct sunlight.

### Examples

Various embodiments of the present disclosure can be better understood by reference to the following Examples which are offered by way of illustration. The present disclosure is not limited to the Examples given herein.

Two sterilant compositions were studied to determine their stability. Specifically the concentration of the hydrogen peroxide and peracetic acid in the composition was determined.

Composition A is a two part solution. The first part includes peracetic acid and hydrogen peroxide. The second part includes isazone and water. The first part and second part are mixed at a ratio of 4% and 96% by volume.

Composition B is a two part solution. The first part includes peracetic acid and hydrogen peroxide. The second part includes isazone and water. The first part and second part are mixed at a ratio 3.6 parts first solution, 16.4 parts second solution and 80 parts water.

To determine the stability of the compositions, the compositions were stored at around 25° C. The concentration of peracetic acid was measured by titration. Two lots of each composition were analyzed. The results are presented in Table 1.

TABLE 1

| | Composition A | | | | Composition B | | | |
|---|---|---|---|---|---|---|---|---|
| | Lot 1 | | Lot 2 | | Lot 1 | | Lot2 | |
| | H₂O₂ | PAA | H₂O₂ | PAA | H₂O₂ | PAA | H₂O₂ | PAA |
| | (ppm) | (ppm) | (ppm) | (ppm) | (ppm) | (ppm) | (ppm) | (ppm) |
| Day 0 | 10941.2 | 2477.6 | 10951.4 | 2485.2 | 10761.0 | 2424.4 | 10869.8 | 2432.0 |
| Day 1 | 10833.46 | 2350.01 | 10853.87 | 2342.40 | 10928.7 | 2388.03 | 10860.67 | 2327.19 |
| Day 2 | 10830.06 | 2296.77 | 10938.90 | 2205.51 | 10850.47 | 2258.74 | 10568.15 | 2182.69 |
| Day 5 | 10989.92 | 2053.40 | 11421.90 | 1863.27 | 10857.27 | 2076.22 | 10884.48 | 1878.48 |
| Day 7 | 10952.51 | 1870.88 | 10853.87 | 1657.93 | 10809.65 | 1886.09 | 10881.08 | 1673.14 |
| Day 9 | 11211.01 | 1726.8 | 11268.84 | 1414.57 | 11091.97 | 1726.38 | 11238.23 | 1543.86 |
| Day 12 | 11102.17 | 1528.65 | 11347.07 | 1163.60 | 11170.20 | 1551.46 | 11156.59 | 1262.46 |
| Day 16 | 11217.82 | 1300.49 | 11340.27 | 882.20 | 11255.23 | 1323.30 | 10792.64 | 950.65 |

Table 1 shows that Compositions A and B maintain good stability over at least 16 days.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

### Exemplary Aspects

The following exemplary aspects are provided, the numbering of which is not to be construed as designating levels of importance:

Aspect 1 provides a sterilant composition comprising:
a first part comprising:
   a hydrogen peroxide component;
   an acetic acid component; and
   a peracetic acid component; and
a second part separated from the first part and comprising:
   a buffer component that is substantially free of a borate.

Aspect 2 provides the sterilant composition of Aspect 1, wherein the hydrogen peroxide component is in a range of from about 4000 ppm to about 9600 ppm of the sterilant composition.

Aspect 3 provides the sterilant composition of any one of Aspects 1 or 2, wherein the hydrogen peroxide component is in a range of from about 5000 ppm to about 8000 ppm of the sterilant composition.

Aspect 4 provides the sterilant composition of any one of Aspects 1-3, wherein the acetic acid component is in a range of from about 1600 ppm to about 4000 ppm of the sterilant composition.

Aspect 5 provides the sterilant composition of any one of Aspects 1-4, wherein the acetic acid component is in a range of from about 2300 ppm to about 2700 ppm of the sterilant composition.

Aspect 6 provides the sterilant composition of any one of Aspects 1-5, wherein the peracetic acid component is in a range of from about 800 ppm to about 2400 ppm of the sterilant composition.

Aspect 7 provides the sterilant composition of any one of Aspects 1-6, wherein the peracetic acid component is in a range of from about 1300 ppm to about 1700 ppm of the sterilant composition.

Aspect 8 provides the sterilant composition of any one of Aspects 1-7, wherein the first part further comprises a stabilizer component.

Aspect 9 provides the sterilant composition of Aspect 8, wherein the stabilizer component is in a range of from about 20 ppm to about 800 ppm of the sterilant composition.

Aspect 10 provides the sterilant composition of any one of Aspects 8 or 9, wherein the stabilizer component is in a range of from about 100 ppm to about 400 ppm of the sterilant composition.

Aspect 11 provides the sterilant composition of any one of Aspects 1-10, wherein the buffer component is in a range of from about 1600 ppm to about 4800 ppm of the sterilant composition.

Aspect 12 provides the sterilant composition of any one of Aspects 1-11, wherein the buffer component is in a range of from about 200 ppm to about 4000 ppm of the sterilant composition.

Aspect 13 provides the sterilant composition of any one of Aspects 1-12, wherein the buffer component comprises less than 2 wt % borate.

Aspect 14 provides the sterilant composition of any one of Aspects 1-13, wherein the buffer component comprises 0 wt % borate.

Aspect 15 provides the sterilant composition of any one of Aspects 1-14, wherein the buffer component comprises ammonium acetate.

Aspect 16 provides the sterilant composition of any one of Aspects 1-15, wherein the second part further comprises an anti-corrosive component.

Aspect 17 provides the sterilant composition of Aspect 16, wherein the anti-corrosive component is in a range of from about 100 ppm to about 600 ppm of the sterilant composition.

Aspect 18 provides the sterilant composition of any one of Aspects 16 or 17, wherein the anti-corrosive component is in a range of from about 200 ppm to about 400 ppm of the sterilant composition.

Aspect 19 provides the sterilant composition of any one of Aspects 16-18, wherein the anti-corrosive component comprises a triazole.

Aspect 20 provides the sterilant composition of any one of Aspects 16-19, wherein the anti-corrosive component comprises benzotriazole.

Aspect 21 provides the sterilant composition of any one of Aspects 1-20, wherein the second part further comprises a solubilizer component.

Aspect 22 provides the sterilant composition of Aspect 21, wherein the solubilizer component is in a range of from about 800 to about 24,000 ppm of the sterilant composition.

Aspect 23 provides the sterilant composition of any one of Aspects 21 or 22, wherein the solubilizer component is in a range of from about 100 ppm to about 2000 ppm of the sterilant composition.

Aspect 24 provides the sterilant composition of any one of Aspects 21-23, wherein the solubilizer component comprises a glycol.

Aspect 25 provides the sterilant composition of any one of Aspects 21-24, wherein the solubilizer component comprises a propylene glycol.

Aspect 26 provides the sterilant composition of any one of Aspects 1-26, wherein the second part further comprises a disinfecter component.

Aspect 27 provides the sterilant composition of Aspect 26, wherein the disinfecter component is in a range of from about 800 ppm to about 2400 ppm of the sterilant composition.

Aspect 28 provides the sterilant composition of any one of Aspects 26 or 27, wherein the disinfecter component is in a range of from about 1000 ppm to about 2000 ppm of the sterilant composition.

Aspect 29 provides the sterilant composition of any one of Aspects 26-28, wherein the disinfecter component comprises a glycol.

Aspect 30 provides the sterilant composition of any one of Aspects 26-29, wherein the disinfecter component comprises a diethylene glycol monoethyl ether.

Aspect 31 provides the sterilant composition of any one of Aspects 1-30, wherein the second part further comprises a surfactant or stabilizer component.

Aspect 32 provides the sterilant composition of Aspect 31, wherein the surfactant or stabilizer component is in a range of from about 6 ppm to about 2000 ppm of the sterilant composition.

Aspect 33 provides the sterilant composition of any one of Aspects 31 or 32, wherein the surfactant component is in a range of from about 120 ppm to about 1000 ppm of the sterilant composition.

Aspect 34 provides the sterilant composition of any one of Aspects 31-33, wherein the surfactant component comprises caprylamidopropyl hydroxypropyl sultaine while the stabilizer component comprises a 2,6-diphenyl-4,8diazoadamantan-1-one or derivative thereof.

Aspect 35 provides the sterilant composition of any one of Aspects 31-34, wherein the surfactant component comprises a diethylene glycol monoethyl ether.

Aspect 36 provides a sterilant composition comprising:
a first part comprising:
   a hydrogen peroxide component;
   an acetic acid component;
   a peracetic acid component; and
   a stabilizer component; and
a second part separated from the first part and comprising:
   a buffer component that is substantially free of a borate;
   an anti-corrosive component;
   a solubilizer component;
   a disinfecter component; and
   a surfactant component and/or a stabilizer.

Aspect 37 provides the sterilant composition of Aspect 36, wherein the hydrogen peroxide component is in a range of from about 4000 ppm to about 9600 ppm of the sterilant composition.

Aspect 38 provides the sterilant composition of any one of Aspects 36 or 37, wherein the hydrogen peroxide component is in a range of from about 5000 ppm to about 8000 ppm of the sterilant composition.

Aspect 39 provides the sterilant composition of any one of Aspects 36-38, wherein the acetic acid component is in a range of from about 1600 ppm to about 4000 ppm of the sterilant composition.

Aspect 40 provides the sterilant composition of any one of Aspects 36-39, wherein the acetic acid component is in a range of from about 2300 ppm to about 2700 ppm of the sterilant composition.

Aspect 41 provides the sterilant composition of any one of Aspects 36-40, wherein the peracetic acid component is in a range of from about 800 ppm to about 2400 ppm of the sterilant composition.

Aspect 42 provides the sterilant composition of any one of Aspects 36-41, wherein the peracetic acid component is in a range of from about 1300 ppm to about 1700 ppm of the sterilant composition.

Aspect 43 provides the sterilant composition of any one of Aspects 36-42, wherein the stabilizer component is in a range of from about 20 ppm to about 800 ppm of the sterilant composition.

Aspect 44 provides the sterilant composition of any one of Aspects 36-43, wherein the stabilizer component is in a range of from about 20 ppm to about 800 ppm of the sterilant composition.

Aspect 45 provides the sterilant composition of any one of Aspects 36-44, wherein the stabilizer component is in a range of from about 100 ppm to about 400 ppm of the sterilant composition.

Aspect 46 provides the sterilant composition of any one of Aspects 36-45, wherein the buffer component is in a range of from about 800 ppm to about 4800 ppm of the sterilant composition.

Aspect 47 provides the sterilant composition of any one of Aspects 36-46, wherein the buffer component comprises less than 2 wt % borate.

Aspect 48 provides the sterilant composition of any one of Aspects 36-47, wherein the buffer component comprises 0 wt % borate.

Aspect 49 provides the sterilant composition of any one of Aspects 36-48, wherein the buffer component comprises ammonium acetate.

Aspect 50 provides the sterilant composition of any one of Aspects 36-49, wherein the anti-corrosive component is in a range of from about 100 ppm to about 600 ppm of the sterilant composition.

Aspect 51 provides the sterilant composition of any one of Aspects 36-50, wherein the anti-corrosive component is in a range of from about 200 ppm to about 400 ppm of the sterilant composition.

Aspect 52 provides the sterilant composition of any one of Aspects 36-51, wherein the anti-corrosive component comprises a triazole.

Aspect 53 provides the sterilant composition of any one of Aspects 36-52, wherein the anti-corrosive component comprises benzotriazole.

Aspect 54 provides the sterilant composition of any one of Aspects 36-53, wherein the solubilizer component is in a range of from about 800 ppm to about 13,000 ppm of the sterilant composition.

Aspect 55 provides the sterilant composition of any one of Aspects 36-54, wherein the solubilizer component is in a range of from about 800 ppm to about 13,000 ppm of the sterilant composition.

Aspect 56 provides the sterilant composition of any one of Aspects 36-55, wherein the solubilizer component comprises a glycol.

Aspect 57 provides the sterilant composition of any one of Aspects 36-56, wherein the solubilizer component comprises a propylene glycol.

Aspect 58 provides the sterilant composition of any one of Aspects 36-57, wherein the disinfecter component is in a range of from about 800 ppm to about 2400 ppm of the sterilant composition.

Aspect 59 provides the sterilant composition of any one of Aspects 36-58, wherein the disinfecter component is in a range of from about 800 ppm to about 2000 ppm of the sterilant composition.

Aspect 60 provides the sterilant composition of any one of Aspects 36-59, wherein the disinfecter component comprises a glycol.

Aspect 61 provides the sterilant composition of any one of Aspects 36-60, wherein the disinfecter component comprises a diethylene glycol monoethyl ether.

Aspect 62 provides the sterilant composition of any one of Aspects 36-61, wherein the surfactant component or stabilizer is in a range of from about 6 ppm to about 2000 ppm of the sterilant composition.

Aspect 63 provides the sterilant composition of any one of Aspects 36-62, wherein the surfactant component or stabilizer is in a range of from about 120 ppm to about 1000 ppm of the sterilant composition.

Aspect 64 provides the sterilant composition of any one of Aspects 36-63, wherein the surfactant component comprises caprylamidopropyl hydroxypropyl sultaine while the stabilizer component comprises a 2,6-diphenyl-4,8diazoadamantan-1-one or derivative thereof.

Aspect 65 provides the sterilant composition of any one of Aspects 36-64, wherein the surfactant component comprises a diethylene glycol monoethyl ether.

Aspect 66 provides the sterilant composition of any one of Aspects 36-65, wherein the first part and the second are combined along with water to form a dispersible sterilant composition.

Aspect 67 provides the sterilant composition of Aspect 66, wherein a dilution ratio of the first part to the second part to the water is in a range of about 0.9-1.1:0.9-1.1:47.8-48.2, 1.8-2.2:47.8-48.2, 1.6-2:8-8.4:39.6-40.4, 1.8-2.2:2.6-3:44.8-45.6.

Aspect 68 provides the sterilant composition of any one of Aspects 66 or 67, wherein the peracetic acid component is present in the dispersible sterilant composition at a concentration in a range of from about 750 ppm to about 1400 ppm.

Aspect 69 provides the sterilant composition of any one of Aspects 66 or 68, wherein the peracetic acid component is present in the dispersible sterilant composition at a range of from about 800 ppm to about 1200 ppm.

Aspect 70 provides the sterilant composition of any one of Aspects 66-69, wherein a pH of the dispersible sterilant composition is in a range of from about 3 to about 7.

Aspect 71 provides the sterilant composition of any one of Aspects 66-70, wherein a pH of the dispersible sterilant composition is in a range of from about 4 to about 6.

Aspect 72 provides a method of making the dispersible sterilant composition of any one of Aspects 66-71, the method comprising contacting the first part and the second part with a common source of water.

Aspect 73 provides a method of using the dispersible sterilant composition of any one of Aspects 1-72, the method comprising contacting the dispersible sterilant composition with a substrate.

Aspect 74 provides the method of Aspect 73, wherein the substrate comprises at least a portion of a medical device, at least a portion of an industrial surface, at least a portion of a residential surface, or a combination thereof.

Aspect 75 provides the method of any one of Aspects 73-74, wherein the dispersible sterilant composition is at a temperature in a range of from about 20° C. to about 50° C.

Aspect 76 provides the method of any one of Aspects 73-75, wherein the dispersible sterilant composition is at a temperature in a range of from about 30° C. to about 40° C.

1-76. (canceled)

77. A sterilant composition comprising:
a first part comprising:
a hydrogen peroxide component in a range of from about 4000 ppm to about 9600 ppm of the sterilant composition;
an acetic acid component in a range of from about 1600 ppm to about 4000 ppm of the sterilant composition; and
a peracetic acid component in a range of from about 800 ppm to about 2400 ppm of the sterilant composition; and
a second part separated from the first part and comprising:
a buffer component that is substantially free of a borate and is in a range of from about 1600 ppm to about 4800 ppm of the sterilant composition.

78. The sterilant composition of claim 77, wherein the first part further comprises a stabilizer component in a range of from about 20 ppm to about 800 ppm of the sterilant composition.

79. The sterilant composition of claim 78, wherein the buffer component comprises ammonium acetate.

80. The sterilant composition of any one of claim 77, wherein the second part further comprises an anti-corrosive component in a range of from about 100 ppm to about 600 ppm of the sterilant composition.

81. The sterilant composition of claim 80, wherein the anti-corrosive component comprises a triazole.

82. The sterilant composition of claim 81, wherein the anti-corrosive component comprises benzotriazole.

83. The sterilant composition of claim 77, wherein the second part further comprises a solubilizer component in a range of from about 800 to about 2400 ppm of the sterilant composition.

84. The sterilant composition of claim 83, wherein the solubilizer component comprises a glycol.

85. The sterilant composition of any one of claim 84, wherein the solubilizer component comprises a propylene glycol.

86. The sterilant composition of claim 77, wherein the second part further comprises a disinfecter component in a range of from about 800 ppm to about 2400 ppm of the sterilant composition.

87. The sterilant composition of claim 86, wherein the disinfecter component comprises a glycol.

88. The sterilant composition of claim 87, wherein the disinfecter component comprises a diethylene glycol monoethyl ether.

89. The sterilant composition of claim 77, wherein the second part further comprises a surfactant component or a stabilizer component in a range of from about 6 ppm to about 2000 ppm of the sterilant composition.

90. The sterilant composition of claim 89, wherein the surfactant component comprises caprylamidopropyl hydroxypropyl sultaine while the stabilizer component comprises a 2,6-diphenyl-4,8diazoadamantan-1-one or derivative thereof.

91. The sterilant composition of claim 90, wherein the surfactant component comprises a diethylene glycol monoethyl ether.

92. The sterilant composition of claim 77, wherein the second part is separated from the first part.

93. The sterilant composition of claim 92, wherein the first part and the second part are combined along with water to form a dispersible sterilant composition.

94. The sterilant composition of claim 93, wherein a pH of the dispersible sterilant composition is in a range of from about 3 to about 7.

95. A method of making a dispersible sterilant composition comprising
a first part comprising:
a hydrogen peroxide component in a range of from about 4000 ppm to about 9600 ppm of the sterilant composition;
an acetic acid component in a range of from about 1600 ppm to about 4000 ppm of the sterilant composition; and
a peracetic acid component in a range of from about 800 ppm to about 2400 ppm of the sterilant composition; and
a second part separated from the first part and comprising:
a buffer component that is substantially free of a borate and is in a range of from about 1600 ppm to about 4800 ppm of the sterilant composition, the method comprising contacting the first part and the second part with a common source of water.

96. A method of using a dispersible sterilant composition comprising
a first part comprising:
a hydrogen peroxide component in a range of from about 4000 ppm to about 9600 ppm of the sterilant composition;
an acetic acid component in a range of from about 1600 ppm to about 4000 ppm of the sterilant composition; and
a peracetic acid component in a range of from about 800 ppm to about 2400 ppm of the sterilant composition; and
a second part separated from the first part and comprising:
a buffer component that is substantially free of a borate and is in a range of from about 1600 ppm to about 4800 ppm of the sterilant composition, the method comprising contacting the dispersible sterilant composition with a substrate comprising at least a portion of a medical device, at least a portion of an industrial surface, at least a portion of a residential surface, or a combination thereof, wherein the dispersible sterilant composition is at a temperature in a range of from about 20° C. to about 50° C.
